(19) United States
(12) Patent Application Publication
(10) Pub. No.: US 2008/0055550 A1
(43) Pub. Date: Mar. 6, 2008

(54) Microprojector

(75) Inventor: Dong-ha Kim, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/818,032

(22) Filed: Jun. 13, 2007

(30) Foreign Application Priority Data
Sep. 4, 2006 (KR) 10-2006-0084830

(51) Int. Cl. G03B 21/28; G03B 21/16

(52) U.S. Cl. 353/20; 353/31

(57) ABSTRACT

A microprojector comprising an illumination optical system, including light sources for green, red and blue laser light beams, first through third focusing lenses arranged in the optical path of the light beams, first through third mirrors diverting the light beams to a rear side of the microprojector, a reflection mirror diverting the light beams upward, a unifying unit, and a polarizing beam splitter; an image display panel reflecting the linearly polarized green, red and blue light beams in the opposite direction to the incident direction as well as selectively rotating the polarization of linearly polarized green, red and blue light beams in accordance with an externally input image signal; and a projection optical system having a plurality of lenses linearly arranged to project the light beams, thereby forming an image onto an external surface. The microprojector includes components arranged in such a way that they occupy a relatively small space.

### CROSS-REFERENCE TO RELATED PATENT APPLICATIONS

This application claims the benefit of Korean Patent Application No. 10-2006-0084830, filed on Sep. 4, 2006, in the Korean Intellectual Property Office, the disclosure of which is incorporated herein in its entirety by reference.

### BACKGROUND OF THE INVENTION

1. Field of the Invention

The present invention relates to a microprojector, and more particularly, to an ultracompact portable microprojector for displaying magnified images on an external screen by connecting portable multimedia apparatuses such as digital cameras, digital camcorders, portable multimedia players (PMPs), laptop computers, and mobile phones to the microprojector.

2. Description of the Related Art

Projectors can be classified into reflection type projectors and transmission type projectors. In reflection type projectors, light beams are reflected by an image display panel, while in transmission type projectors, light beams are transmitted by an image display panel. Projectors can also be classified into single-panel type, two-panel type, and three-panel type projectors according to the number of image display panels.

Some projectors use lamp light sources, while other projectors use laser light sources. Lamp light sources are generally larger in size than laser light sources. Thus, projectors using lamp light sources are typically large and difficult to carry. To overcome this disadvantage, technology and configurations for projectors using laser light sources that are relatively smaller in size are being actively developed. Japanese Patent Publication Nos. 2000-347291 and 2001-264662, Japanese Patent Publication No. Hei 11-64789, and Korean Patent Registration No. 0519348 disclose projectors using one or more laser light sources.

Currently, there is a growing trend in the use of portable multimedia apparatuses such as digital cameras, digital camcorders, portable multimedia players (PMPs), laptop computers, and mobile phones. As the use of portable multimedia apparatuses increases, so do the opportunities for users of portable multimedia apparatuses to share images by using projectors. However, the portability and mobility of projectors must improve in order to increase their use with portable multimedia apparatuses. Since portable multimedia apparatuses are compact and easy to carry, projectors also need to be compact and easy to carry, so that they can be easily carried with portable multimedia apparatuses. A projector may even need to be small enough to be carried in a coat pocket or to be integrated into a portable multimedia apparatus. Thus, to increase the use of projectors with portable media apparatuses, improved technology and configurations of projectors using laser light sources are needed.

### SUMMARY OF THE INVENTION

The present invention overcomes the deficiencies of the prior art by providing a compact microprojector including optical components arranged in such a way that they occupy a relatively small space. In one embodiment, the microprojector contains an illumination optical system, a reflection type image display panel and a projection optical system. In this embodiment, the illumination optical system includes light sources having downward-facing exit holes for green (G), red (R), and blue (B) laser light beams, first through third focusing lenses arranged under the respective light sources and controlling the width of each of the light beams, first through third mirrors arranged under the first through third focusing lenses and reflecting the light beams by about 90° so the light beams proceed to a rear side of the microprojector, a reflection mirror reflecting the reflected light beams by about 90° so the light beams proceed upward, a unifying unit producing a uniform light strength distribution of each of the light beams proceeding upward of the microprojector, and a PBS (polarizing beam splitter) reflecting a linearly polarized light beam of the unified light beams so the polarized light beam proceeds to the rear side of the microprojector. The image display panel of this embodiment has pixels forming a plurality of rows and columns and reflects the linearly polarized G, R, and B light beams in a direction opposite to the incident direction and also selectively rotates the polarization of linearly polarized G, R, and B light beams output from the illumination optical system that are incident on selected pixels in accordance with an image signal received from an internal or external source, such as a portable multimedia apparatus. The projection optical system of this embodiment has a plurality of lenses linearly arranged to project the G, R, and B light beams forming an image onto an external screen.

A second embodiment of the microprojector is adapted to use a transmission type image display panel. A third embodiment is adapted to be embedded in a portable media apparatus. The disclosed microprojector embodiments have small volumes, making them relatively easy to carry.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of a microprojector according to an embodiment of the present invention;

FIG. 2 shows a configuration of an optical system viewed from the side of the microprojector of FIG. 1;

FIG. 3A shows the path of a light beam emitted from a green (G) light source and passing through a first focusing lens;

FIG. 3B shows the path of a light beam emitted from a red (R) light source and passing through a second focusing lens;

FIG. 3C shows the path of a light beam emitted from a blue (B) light source and passing through a third focusing lens;

FIG. 4 shows the shapes and polarization directions of the light beams emitted from the G, R, and B light sources;

FIG. 5 is a perspective view of a heat radiation portion of the microprojector of FIG. 1;

FIG. 6 shows paths of the rays of a light beam passing through a unifying unit of the microprojector of FIG. 1;

FIG. 7 shows the G, R, and B light beams which are incident on the effective area of a micro fly-eye lens of the unifying unit of FIG. 6;

FIG. 8 is a section view of an LCoS (liquid crystal on silicon) panel;

FIG. 9A shows a PBS (polarizing beam splitter) and the proceeding direction and polarization direction of light incident on an image display panel;

FIG. 9B shows the proceeding direction and polarization direction of the incident light of FIG. 9A when pixels are OFF in the image display panel;

FIG. 9C shows the proceeding direction and polarization direction of the incident light of FIG. 9A when pixels are ON in the image display panel; and

FIG. 10 shows the configuration of an optical system viewed from the side of a microprojector according to another embodiment of the present invention which uses a transmission type image display panel.

### DETAILED DESCRIPTION OF THE INVENTION

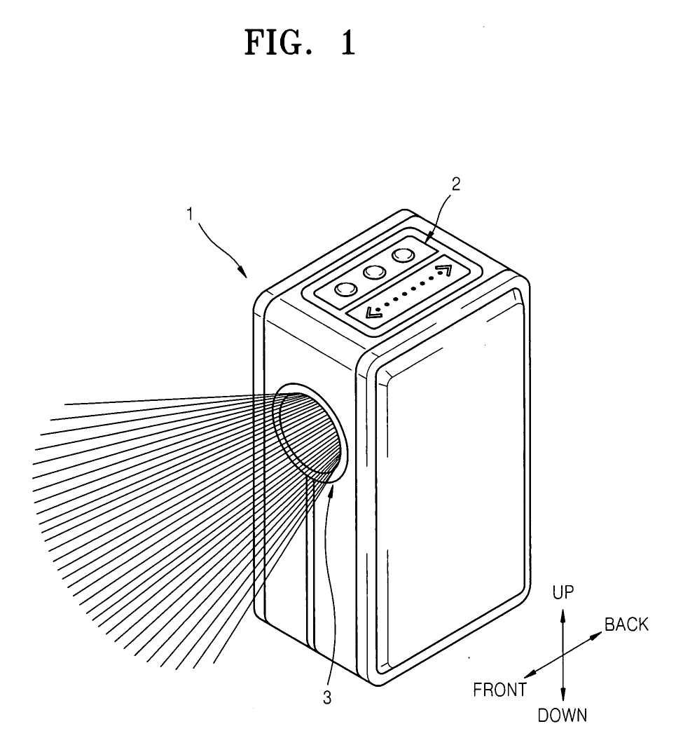

FIG. 1 is a perspective view of a microprojector 1 according to an embodiment of the present invention. The microprojector 1 has a cubic shape. A beam emission hole 3 through which a light beam is emitted toward an external screen is positioned in the upper portion of a front surface of the microprojector 1. A menu button portion 2 for operating the microprojector 1 is arranged on the upper surface of the microprojector 1. Although it is not shown in the drawing, an input port is positioned on the rear surface of the microprojector 1 for receiving an image signal from a portable multimedia apparatus, such as a digital camera, a digital camcorder, a portable multimedia player (PMP), a laptop computer, a mobile phone, or any other apparatus capable of displaying an image or outputting an image signal.

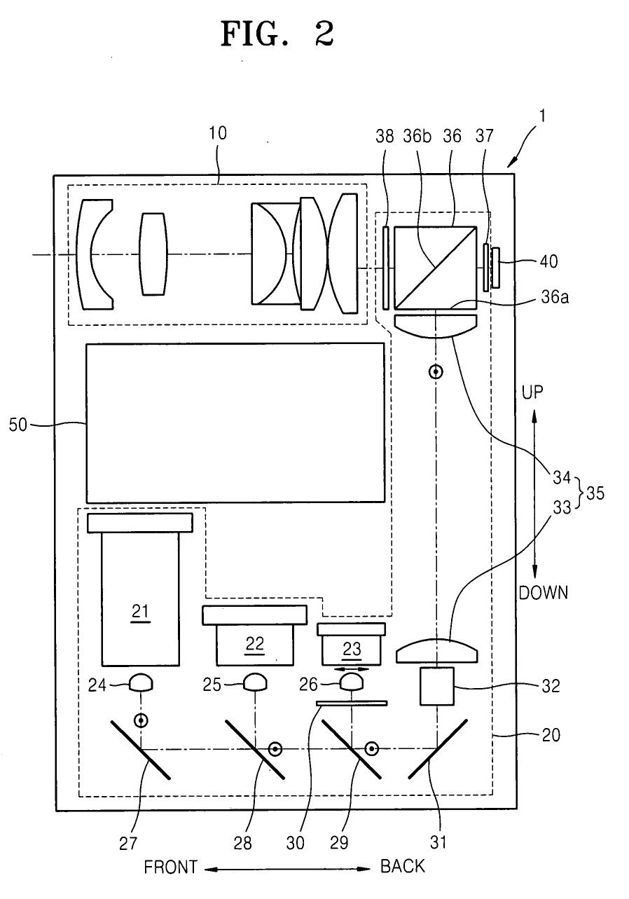

FIG. 2 shows a configuration of an optical system viewed from the side of the microprojector of FIG. 1. It is important to note that the configurations disclosed in the embodiment in FIG. 2 and the other embodiments disclosed herein may also be used for optical systems contained within portable multimedia apparatuses. Referring to FIG. 2, the optical system of the microprojector 1 includes an illumination optical system 20 and a projection optical system 10. The illumination optical system 20 includes a green (G) light source 21, a red (R) light source 22, a blue (B) light source 23, first through third focusing lenses 24, 25, and 26, first through third mirrors 27, 28, and 29, a reflection mirror 31, a unifying unit 35, a PBS (polarizing beam splitter) 36, and an image display panel 40. The projection optical system 10 includes a series of lenses through which the light beam from the image display panel 40 passes.

A light source is a laser light source and includes the G light source 21, the R light source 22, and the B light source 23. In the present embodiment, the G light source 21 is a diode pumping solid state (DPSS) laser and the R light source 22 and the B light source 23 are laser diodes (LDs). The LD and DPSS lasers are smaller than other laser light sources. The G light beam emitted by the DPSS laser has a smaller radial distance than those of the R and B light beams emitted by the LD laser due to superior linearity of the DPSS laser.

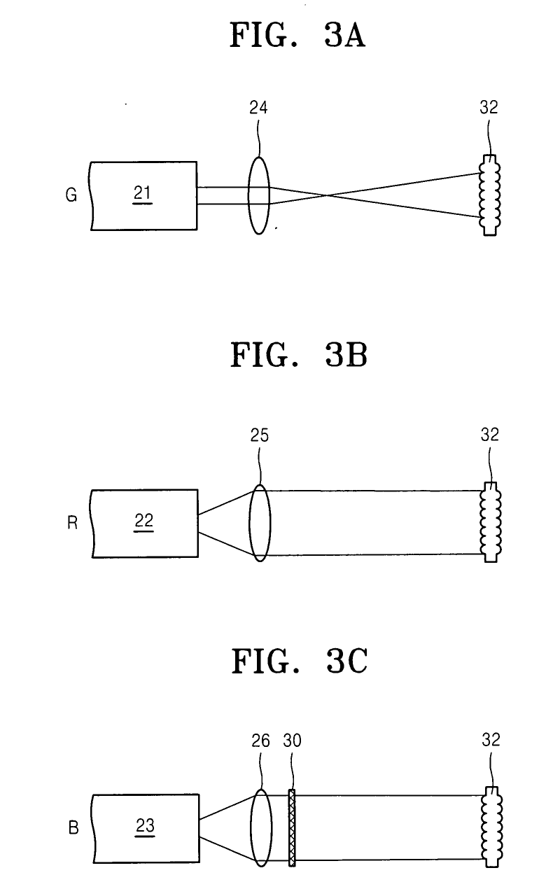

FIGS. 3A through 3C show in detail the width of each of the G, R, and B light beams emitted from the G light source 21, the R light source 22, and the B light source 23. As shown in the drawings, the width of the light beam of the G light source 21 is narrower than that of the light beam emitted from the R light source 22 or the B light source 23. However, each of the light beams is incident on a micro fly-eye lens 32 with a predetermined size. Thus, as shown in FIG. 3A, the of the light beam from the G light source 21 needs to be increased and the first focusing lens 24 is used for this purpose. The first focusing lens 24 is arranged at a side of the G light source 21 through which the light beam exits, that is, under the G light source 21. The first focusing lens 24 increases the radial distance of the G light beam so that radial distance of the G light beam corresponds to the width of the micro fly-eye lens 32.

The radial distance of each of the light beams from the R light source 22 and the B light source 23 is greater than that of the light beam of the G light source 21. Likewise, as shown in FIGS. 3B and 3C, the second focusing lens 25 and the third focusing lens 26 are used to adjust the width of the R light beam and the G light beam respectively to be a predetermined size. The second focusing lens 25 is arranged at a side of the R light source 22 through which the light beam exits and the third focusing lens 26 is arranged at a side of the B light source 23 through which the light beam exits. The predetermined size means a size at which the radial distance of each light beam matches the width of the micro fly-eye lens 32 which will be described later.

The light sources are arranged such that the G light source 21 is farthest from the unifying unit 35, followed by the R light source 22, followed by the B light source 23. This is to secure a proceeding distance sufficient to enable the width of the G light beam that is relatively narrow to increase to a predetermined width as a result of the first focusing lens 24. In case that the radial distance of the R light beam is shorter than that of the B light beam, since the proceeding distance of the R light beam must be greater than the proceeding distance of the B light beam, the R light source 22 can be arranged farther from the unifying unit 35 than the B light source 23. However, it must be understood that the arrangement of the light sources is not limited to the above description but can be modified according to the type of the light source to be adopted.

The first through third mirrors 27, 28, and 29 are respectively arranged under the first through third focusing lenses 24, 25, and 26. The first mirror 27 reflects the G light beam by about 90° counterclockwise. That is, the G light beam proceeding downward proceeds to the rear side of the microprojector 1. The second mirror 28 is a dichroic filter that reflects the R light beam by about 90° to the rear side of the microprojector 1 and transmits the G light beam. The third mirror 29 is a dichroic filter that reflects the B light beam by about 90° to the rear side of the microprojector 1 and transmits the G light beam and the R light beam. As a result, the G, R, and B light beams respectively emitted from the G, R, and B light sources 21, 22, and 23 all proceed toward the reflection mirror 31.

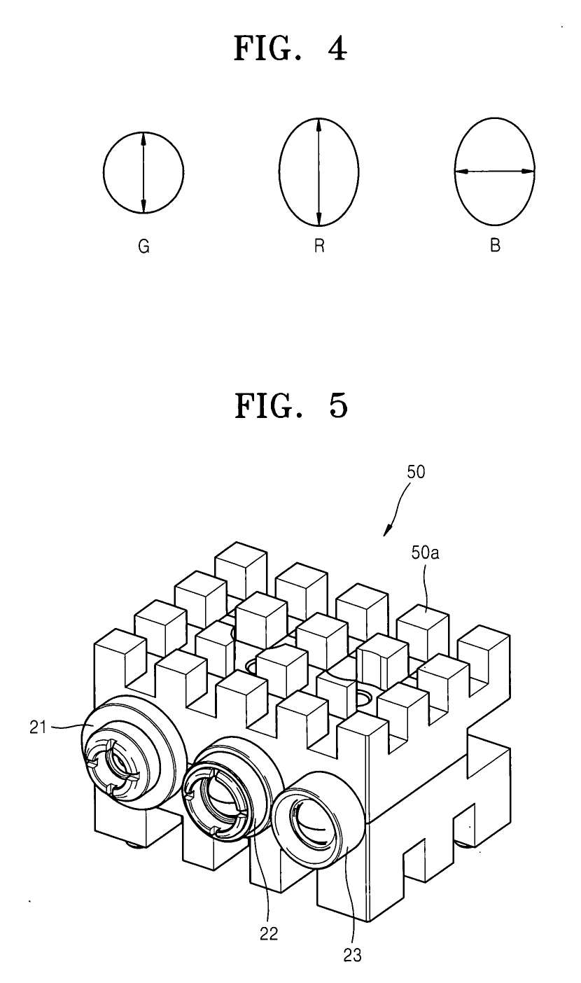

FIG. 4 shows the shapes and polarization directions of the light beams emitted from the G, R, and B light sources 21, 22, and 23. Referring to FIG. 4, the G light source 21 has a roughly circular shape and a polarization in the vertical direction in a section perpendicular to the proceeding direction. The R light source 22 has an oval shape and a polarization in the vertical direction in a section perpendicular to the proceeding direction. The B light source 23 has an oval shape and a polarization in the horizontal direction in a section perpendicular to the proceeding direction.

However, to ensure the light incident on the PBS 36, which will be described later, is not lost the polarization of the light beam incident on the micro fly-eye lens 32, as shown in FIG. 7, must be in the vertical direction in a section perpendicular to the proceeding direction. Thus, there is a need to convert the polarization of the B light beam in the horizontal direction to a polarization in the vertical direction. For this purpose, a λ/2 filter (half wave plate) 30 is arranged under the B light source 23. Thus, after the B light beam passes through the λ/2 filter 30, the G, R, and B light beams are polarized in the same vertical direction, perpendicular to the proceeding direction so that light incident on the PBS 36 is not lost.

The G, R, and B light beams are emitted from the G, R, and B light sources 21, 22, and 23 according to an output signal from a control portion (not shown) which will be described later. The output signal from the control portion is based on an image signal received through an input channel connected to a source, such as a portable multimedia apparatus.

The microprojector 1 according to the present embodiment further includes the control portion and a heat radiation portion 50 in addition to the illumination optical system 20 and the projection optical system 10. The control portion controls the operations of the G, R, and B light sources 21, 22, and 23 and the operation of the image display panel 40 according to image signals from a source, such as a portable multimedia apparatus. The heat radiation portion 50 radiates heat generated from the G, R, and B light sources 21, 22, and 23. For this purpose, the heat radiation portion 50 encompasses or is adjacent to the G, R, and B light sources 21, 22, and 23 and has a plurality of heat radiation fins 50a formed on the surface of the heat radiation portion 50 to increase the area through which heat may be radiated.

The reflection mirror 31 reflects the G, R, and B light beams emitted from the respective light sources 21, 22, and 23 and reflected by the first through third mirrors 27, 28, and 29 by about 90° upward. That is, all the light beams proceeding to the rear side proceed upward after reflection by the reflection mirror 31. The reflection mirror 31 reflects all of the G, R, and B light beams.

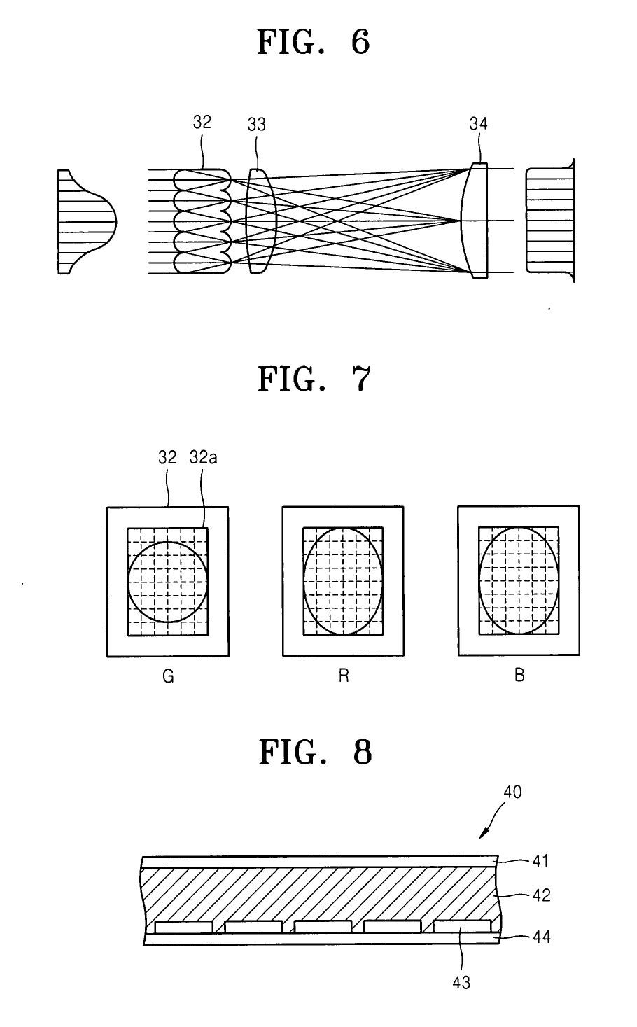

The respective light beams reflected by the reflection mirror 31 are incident on the unifying unit 35. The purpose of the unifying unit is to give the G, R, B and B light beams a substantially uniform light strength, and it can be implemented in a number of ways. FIG. 6 shows one embodiment of a unifying unit 35 and the path of the rays of a light beam passing through the unifying unit 35. As an example of the unifying unit 35, the micro fly-eye lens 32, a fourth focusing lens 33, and a collimation lens 34 are used. The micro fly-eye lens 32 is arranged above the reflection mirror 31, the fourth focusing lens 33 is arranged above the micro fly-eye lens 32, and the collimation lens 34 is arranged above the fourth focusing lens 33.

As shown in FIG. 7, each incident light beam must be accurately disposed on the whole of an effective area 32a of the micro fly-eye lens 32, which can be achieved by adjusting the focusing lenses 24, 25, and 26 arranged under the respective light sources.

The light strength distribution of the light beam incident on the micro fly-eye lens 32 is great in the central portion and small in the circumferential portion as shown in FIG. 6. The incident light beam is split by the micro fly-eye lens 32. Each of the split light beams pass through the fourth focusing lens 33 and are incident on the whole of the collimation lens 34. That is, as each ray of the split light beams at the central portion and each ray of the split light beams of both circumferential portions are incident on the whole of the collimation lens 34 as a result of the fourth focusing lens 33, the light strength distribution of the light beam passing through the collimation lens 34 is made uniform. Thus, the light strength distribution of the light beam incident on the PBS 36 is uniform.

Although in the embodiment shown in FIG. 2, the unifying unit 35 includes the micro fly-eye lens 32, a diffraction optical element (DOE, not shown) may be included instead. The DOE separates the incident light by diffracting the same. To this end, the DOE includes a diffraction grid and the shape of the diffraction grid can be modified in various ways by those skilled in the art.

The image display panel 40 forms an image by modulating a light beam according to an image signal input from the outside. The image display panel 40 may be, for example, a DMD (digital micromirror display) panel, an LCoS (liquid crystal on silicon) panel, and a diffractive optical display device. In the embodiment shown in FIG. 2, the image display panel 40 is an LCoS panel.

FIG. 8 is a sectional view of the LCoS panel. Referring to FIG. 8, an LCoS panel 40 includes ITO (indium tin oxide) glass 41, liquid crystal 42, aluminum pixels 43, and a CMOS substrate 44. The incident light passing through the ITO glass 41 is reflected from the aluminum pixels 43 while the polarization direction thereof is rotated by 90°, or maintained as it is, according to the arrangement of molecules of the liquid crystal 42 corresponding to each aluminum pixel 43. The arrangement of molecules of the liquid crystal 42 is controlled according to a voltage applied to electrodes (not shown) of each aluminum pixel 43 through the CMOS substrate 44. That is, the control portion applies a voltage to a particular aluminum pixel 43 corresponding to the image signal input from the external source. As the arrangement of molecules of the liquid crystal 42 corresponding to the particular aluminum pixel 43 changes, according to the applied potential difference, the polarization direction of the light beam is controlled.

Unlike in the transmission type LCD, in the LCoS panel 40, the light beam input through the liquid crystal 42 is reflected and emitted. That is, the light beam does not the pass through the CMOS, but is instead reflected and emitted through the ITO glass 41. Thus, the numerical aperture (NA) is high and the LCoS panel 40 has high brightness compared to that of the transmission type LCD.

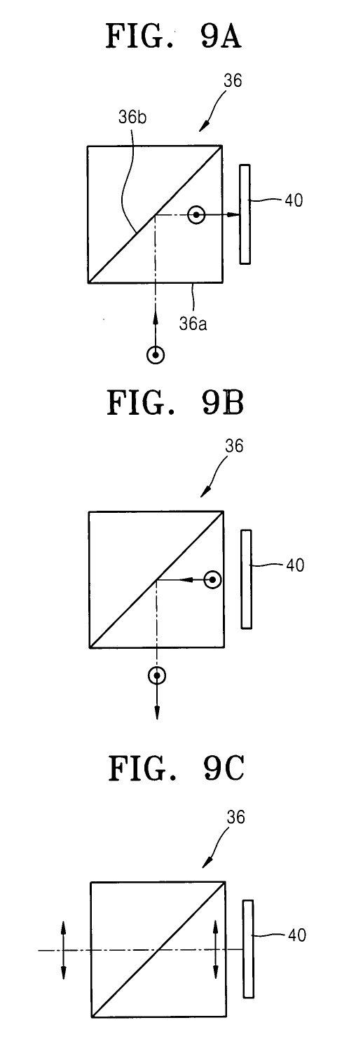

Referring to FIGS. 9A through 9C, the method via which the PBS 36 and the image display panel 40 make the respective light beams output from the unifying unit 35 proceed toward the projection optical system 10 is described. As shown in FIG. 9A, the respective light beams having a uniform light strength and a polarization in the vertical direction in a section perpendicular to the proceeding direction are incident on the PBS 36. The PBS 36 reflects only one of the light beams output from the unifying unit 35, which has a polarization in a predetermined direction, that is, in the present embodiment, a polarization in the vertical direction in a section perpendicular to the proceeding direction of the light beam, by about 90° counterclockwise. That is, the PBS 36 reflects only the light beam having a polarization in the vertical direction causing it to proceed to the rear side while transmitting the other light beams. The reflected light beam having a polarization in the vertical direction is incident on the image display panel 40.

As shown in FIG. 9B, the light beam incident on an aluminum pixel 43 in a black state (OFF state) of the image display panel 40 is reflected by the image display panel 40 maintaining the same polarization direction. As a result, since the reflected light beam is reflected again by the PBS 36, the light beam no longer proceeds toward the projection optical system 10. Thus, the G, R, and B light beams are not projected to the external screen in the black state.

As shown in FIG. 9C, the light beam incident on an aluminum pixel 43 in a white state (ON state) of the image display panel 40 is reflected by the image display panel 40 with its polarization direction rotated by 90°. As a result, since the reflected light beam has a polarization in the vertical direction in a section perpendicular to the proceeding direction, the PBS 36 transmits the light beam and the light beam then proceeds toward the projection optical system 10. Thus, the G, R, and B light beams are projected to the external screen in the white state. The aluminum pixel 43 to which a voltage is applied can be set to be in a white state or in a black state.

The light beam passing through the unifying unit 35 must be perpendicularly incident on an incident surface 36a of the PBS 36. However, in an actual situation, a skew ray that is not perpendicular to the incident surface 36a is present and the skew ray is reflected with its polarization direction slightly being rotated. To correct this, a λ/4 filter 37 can be additionally arranged on an optical path between the PBS 36 and the image display panel 40.

Also, a polarizer 38 can be additionally arranged between the PBS 36 and the projection optical system 10. The polarizer 38 transmits only the light beam having a polarization in the vertical direction in a section perpendicular to the proceeding direction of the light beam. That is, the polarizer 38 filters out polarizations other than a desired polarization. Thus, the A/4 filter 37 and/or polarizer 38 improve the contrast of an image.

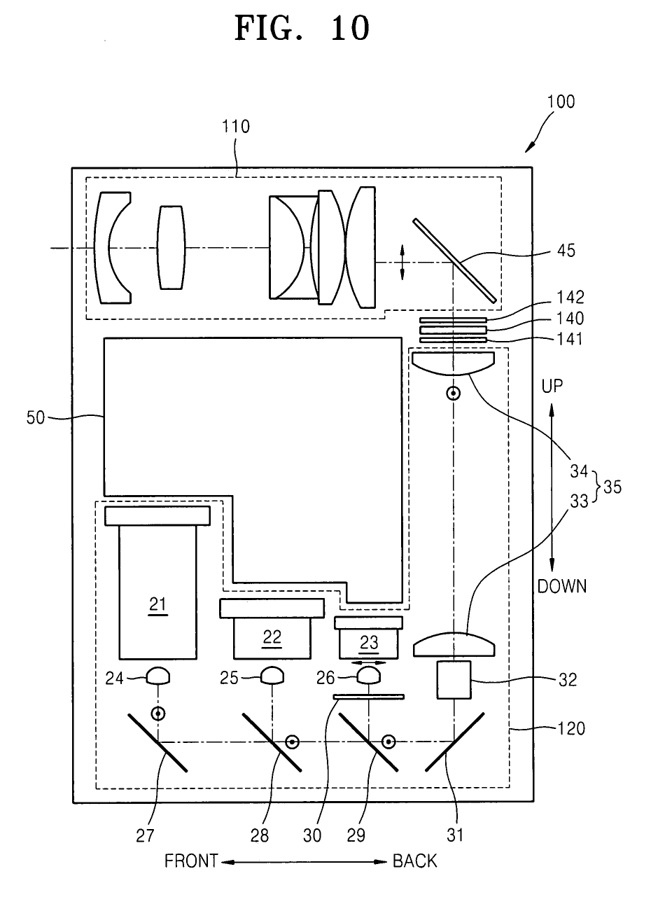

Although the reflection type image display panel 40 is used in the embodiment shown in FIG. 2, a transmission type image display panel 140, such as a transmission type LCD panel, can also be used as shown in the embodiment in FIG. 10.

FIG. 10 shows the configuration of an optical system using a transmission type image display panel 140 viewed from the side of a microprojector 100 according to another embodiment of the present invention. The transmission type LCD 140 is arranged on the optical path after the fourth focusing lens 33 and the collimation lens 34 and a second reflection mirror 45 is arranged at the position of the PBS 36 of FIG. 2. That is, the transmission type LCD panel 140 is arranged on the optical path between the collimation lens 34 and the second reflection mirror 45. A first polarization plate 141 and a second polarization plate 142 are arranged under and above the transmission type LCD panel 140 respectively.

Thus, the light beams incident on pixels of the LCD panel 140 that are selected based on an image signal received from a device, such as a portable media apparatus, pass through the second polarization plate 142 with their polarization directions changed according to changes in the arrangement of liquid crystal corresponding to the selected aluminum pixels. As a result, only the light beams forming an image corresponding to the image signal proceed toward a projection optical system 110.

The projection optical system 110 projects the light beam for forming an image onto an external screen (not shown) and includes a plurality of lenses that are linearly arranged. The type, number, and arrangement of the lenses adopted in the projection optical system 110 can be modified by those skilled in the art without departing from the spirit and scope of the present invention.

The operation of the microprojector 1 according to the above-described first embodiment of the present invention of magnifying an image and projecting the image on the screen will now be described below.

When the microprojector 1 is connected to a multimedia apparatus, an image signal from the multimedia apparatus is input to the control portion of the microprojector. The control portion outputs an output signal to form an image on the image display panel 40 according to the input image signal. Then, a change in the arrangement of the liquid crystal 42 corresponding to a particular pixel occurs to form an image. The G, R, and B light sources 21, 22, and 23 are operated by the control portion to be engaged with the image display panel 40. G, R, and B light beams are sequentially emitted from the respective light sources 21, 22, and 23.

The respective light beams sequentially pass through the first through third focusing lenses 24, 25, and 26 and are reflected by the first through third mirrors 27, 28, and 29 to be incident on the reflection mirror 31. The light beams reflected by the reflection mirror 31 are given a uniform light strength by the unifying unit 35. Of the light beams having the uniform light strength distribution, only a light beam having a polarization in a predetermined direction is reflected by the PBS 36 and incident on a reflection type image display panel 40 such as an LCoS.

The light beams incident on the particular pixels of the image display panel 40 according to the image signal are reflected, and then proceed in the opposite direction to the incident direction with their polarization directions rotated by 90° and pass through the PBS 36 to be incident on the projection optical system 10. The incident light beams are magnified while passing through the projection optical system 10 so that a magnified image can be projected onto the external screen. The G, R, and B light beams are sequentially projected onto the external screen for a very short time. That is, a G image, an R image, and a B image are sequentially projected onto the external screen at times separated by very short time intervals. As a result, the projected R image, G image, and B image appear to overlap one another to form a single image. Thus, as the images are continuously projected, a moving image is formed.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A microprojector comprising:
an illumination optical system including
a first, second and third light source, each light source emitting a laser light beam in a first direction, each light beam being selected from the group consisting of a green, red and blue light beam,
a first, second and third focusing lens, each lens arranged in the beam path of one of the green, red and blue light beams, each lens controlling the width of one of the green, red and blue light beams,
a first, second and third mirror, each mirror arranged in the beam path of one of the green, red and blue light beams, each mirror diverting the beam path of one of the green, red and blue light beams in a second direction, the second direction being generally perpendicular to the first direction,
a reflection mirror diverting the beam paths of the green, red and blue light beams in a third direction, the third direction being generally perpendicular to the second direction and generally parallel to the first direction,
a unifying unit producing a substantially uniform light strength for each of the green, red and blue light beams, and
a polarizing beam splitter diverting linearly polarized green, red and blue light beams in a fourth direction, the fourth direction being generally perpendicular to the third direction and generally parallel to the second direction;
an image display panel having pixels forming a plurality of rows and columns, the image display panel reflecting the linearly polarized green, red and blue light beams as well as selectively rotating the polarization of the linearly polarized green, red and blue light beams that are incident on pixels selected in accordance with an image signal; and
a projection optical system having a plurality of lenses linearly arranged to project the green, red and blue light beams onto an external surface.

2. The microprojector of claim 1, wherein the light sources are arranged such that the light source emitting the green light beam is the farthest from the unifying unit, followed by the light source emitting the red light beam, followed by the light source emitting the blue light beam.

3. The microprojector of claim 2, wherein the light sources emitting the red and blue light beams are laser diodes and the light source emitting the green light beam is a diode pumping solid state laser.

4. The microprojector of claim 2, wherein the first mirror reflects the green light beam, the second mirror is a dichroic filter that reflects only the red light beam, and the third mirror is a dichroic filter that reflects only the blue light beam.

5. The microprojector of claim 1, wherein the image display panel is selected from the group consisting of a liquid crystal on silicon display panel and a digital micromirror display panel.

6. The microprojector of claim 1, wherein the image display panel is a liquid crystal on silicon panel and a λ/4 filter is positioned between the polarizing beam splitter and the liquid crystal on silicon panel.

7. The microprojector of claim 1, wherein a polarizer is positioned between the polarizing beam splitter and the projection optical system.

8. The microprojector of claim 1, wherein the unifying unit includes
a micro fly-eye lens splitting the green, red and blue light beams, and
a fourth focusing lens and a collimation lens collecting the split green, red and blue light beams and producing a uniform light strength for each of the split green, red and blue light beams.

9. The microprojector of claim 1, wherein the unifying unit includes
a diffraction optical element splitting the green, red and blue light beams, and
a fourth focusing lens and a collimation lens collecting the split green, red and blue light beams and producing a uniform light strength for each of the split green, red and blue light beams.

10. The microprojector of claim 4, further comprising a λ/2 filter positioned between the light source emitting the blue light beam and the third mirror, the λ/2 filter rotating the polarization of the blue light beam so that the polarization of the blue light beam is in the same direction as the polarization of the red and green light beams.

11. The microprojector of claim 1, further comprising a controller controlling the image display panel and the emission of the green, red and blue light beams by the first, second and third light sources according to the image signal.

12. The microprojector of claim 1, further comprising a heat member radiating the heat generated by the first, second and third light sources.

13. The microprojector of claim 12, wherein the heat member is disposed between a set of the first, second and third light sources and the projection optical system.

14. A microprojector comprising:
an illumination optical system including
a first, second and third light source, each light source emitting a laser light beam in a first direction, each light beam being selected from the group consisting of a green, red and blue light beam,
a first, second and third focusing lens, each lens arranged in the beam path of one of the green, red and blue light beams, each lens controlling the width of one of the green, red and blue light beams,
a first, second and third mirror, each mirror arranged in the beam path of one of the green, red and blue light beams, each mirror diverting the beam path of one of the green, red and blue light beams in a second direction, the second direction being generally perpendicular to the first direction,
a reflection mirror diverting the beam paths of the green, red and blue light beams in a third direction, the third direction being generally perpendicular to the second direction and generally parallel to the first direction, and
a unifying unit producing a substantially uniform light strength for each of the green, red and blue light beams;
a transmission type image display panel having pixels forming a plurality of rows and columns, the transmission type image display panel transmitting the green, red and blue light beams as well as selectively rotating the polarization of the green, red and blue light beams that are incident on pixels selected in accordance with an image signal; and
a projection optical system having a plurality of lenses linearly arranged to project the green, red and blue light beams onto an external surface.

15. The microprojector of claim 14, wherein the transmission type image display panel is a transmission type LCD panel.

16. The microprojector of claim 15, wherein the transmission type LCD panel is positioned between a first polarization plate and a second polarization plate.

17. The microprojector of claim 14, wherein the unifying unit includes
a micro fly-eye lens splitting the green, red and blue light beams, and
a fourth focusing lens and a collimation lens collecting the split green, red and blue light beams and producing a uniform light strength for each of the split green, red and blue light beams.

18. The microprojector of claim 14, wherein
the third mirror is arranged in the beam path of the blue light beam, and
a λ/2 filter is positioned between the light source emitting the blue light beam and the third mirror, the λ/2 filter rotating the polarization of the blue light beam so that the polarization of the blue light beam is in the same direction as the polarization of the red and green light beams.

19. The microprojector of claim 14, further comprising a heat radiation portion encompassing the first, second and third light sources, the heat radiation portion radiating the heat generated by the first, second and third light sources.

20. The optical system of claim 1, wherein the optical system is embedded in a portable media apparatus.

21. The optical system of claim 1, wherein the portable media apparatus is selected from the group consisting of a digital camera, digital camcorder, portable media player, laptop, and mobile phone.

22. An optical system for projecting images comprising:
a first, second and third light source, each light source emitting a laser light beam in a first direction, each light beam being selected from the group consisting of a green, red and blue light beam;
a first, second and third mirror, each mirror arranged in the beam path of one of the green, red and blue light beams, each mirror diverting one of the green, red and blue light beams toward a second direction, the second direction being generally perpendicular to the first direction;
a reflection mirror diverting the green, red and blue light beams in a third direction, the third direction being generally perpendicular to the second direction and generally parallel to the first direction;
a unifying unit producing a substantially uniform light strength distribution of each of the green, red and blue light beams proceeding in the third direction; and
a projection optical system having a plurality of lenses linearly arranged to project the green, red and blue light beams onto an external surface.

23. The optical system of claim 22, wherein the light sources are arranged such that the light source emitting the green light beam is the farthest from the unifying unit, followed by the light source emitting the red light beam, followed by the light source emitting the blue light beam.

24. The optical system of claim 22, wherein the green, red and blue light beams pass through a polarizer before reaching the projection optical system.

25. The optical system of claim 22, wherein the light sources emitting the green, red and blue light beams are each selected from the group consisting of a laser diode and a diode pumping solid state laser.

26. The optical system of claim 22, wherein the unifying unit includes
a splitting device that splits the green, red and blue light beams, the splitting device selected from the group consisting of a micro fly-eye lens and diffraction optical element, and
a focusing lens and a collimation lens collecting the split green, red and blue light beams and producing a uniform light strength for each of the split green, red and blue light beams.

27. The optical system of claim 22, further comprising a λ/2 filter in the beam path of the blue light beam, the λ/2 filter rotating the polarization of the blue light beam so that the polarization of the blue light beam is in the same direction as the polarization of the red and green light beams.

28. The optical system of claim 22, further comprising a heat member radiating the heat generated by the first, second and third light sources.
